(19) United States
(12) Patent Application Publication
(10) Pub. No.: US 2017/0314942 A1
(43) Pub. Date: Nov. 2, 2017

(54) PRESENTATION OF REAL-TIME PERSONALIZED TRANSIT INFORMATION

(71) Applicant: Microsoft Technology Licensing, LLC, Redmond, WA (US)

(72) Inventor: Silvana P. Moncayo Torres, Seattle, WA (US)

(73) Assignee: Microsoft Technology Licensing, LLC, Redmond, WA (US)

(21) Appl. No.: 15/141,690

(22) Filed: Apr. 28, 2016

(51) Int. Cl. G01C 21/34; G01S 19/42; H04B 1/3827; H04L 29/08

(52) U.S. Cl. CPC G01C 21/3415; H04L 67/12; G01S 19/42; H04B 1/3833

(57) ABSTRACT

A mobile computing device comprises a display, one or more travel sensors configured to measure one or more travel parameters, a logic machine, and a storage machine. The storage machine holds instructions executable by the logic machine to determine a user destination based on one or more personalized travel characteristics, during travel according to an initial transit plan to reach the user destination, measure, via the one or more travel sensors, one or more travel parameters, recognize a travel deviation condition based on the one or more travel parameters, and present, via the display, a notification of an alternative transit plan based on the travel deviation condition.

### BACKGROUND

A computing device may be configured to visually present various transit information to aid a user during travel. For example, such transit information may include a map canvas that presents locations of different transit stations (e.g., train stations, bus stops, taxi cab stands), real-time traffic information, and various places of interest. Furthermore, the computing device may be configured to present a transit plan to travel from a specified location to a specified destination. For example, the computing device may present turn-by-turn directions from the specified location to the specified destination.

### BRIEF DESCRIPTION OF THE DRAWINGS

FIG. 1 shows a computing system for enabling presentation of real-time personalized transit information via a mobile computing device.

FIG. 2-5 show different scenarios in which alternative transit plans are presented during travel to a specified destination according to an initial transit plan based on a travel deviation condition.

FIG. 6 shows a method for presenting real-time personalized transit information.

FIG. 7 shows a computing system.

### DETAILED DESCRIPTION

A computing device may be configured to present travel information in the form of a transit plan to travel from a starting location to a destination. For example, a user may specify the starting location as well as the destination prior to initiating travel, and the computing device may present a transit plan in the form of turn-by-turn directions and/or a route highlighted on a map from the specified location to the destination. Once travel to the destination is initiated, the computing device may update the turn-by-turn directions and the route on the map as the location of the computing device changes.

However, in such an approach, the computing device does not significantly deviate from the transit plan once the transit plan is determined unless the user specifies a different destination. For example, if a location of the computing device deviates from the route specified by the transit plan—e.g., the user makes a wrong turn, then the computing device only alters the turn-by-turn directions and the highlighted route on the map in order to re-direct the computing device back to the original route determined by the transit plan. In such an approach, the computing device does not proactively offer transit information that is most-optimal based on dynamically changing travel conditions during travel to the destination. Moreover, in such an approach, the computing device does not initially provide a transit plan or deviate from the transit plan once initiated without some form of manual user action (e.g., manually specifying a destination and/or manually changing the destination).

Accordingly, the present description is directed to an approach for proactively providing alternative transit plans based on dynamically changing travel conditions. The alternative transit plans may include switching to different public transit routes or different transit modalities in order to travel in a most efficient manner for the current travel conditions. In particular, such an approach leverages various sensors of a mobile computing device to, during travel to a specified destination according to an initial transit plan, identify dynamically changing travel conditions, and provide an alternative transit plan that is better suited to the changed conditions. Moreover, such an approach may fluffier leverage user activity on the mobile computing device to determine personalized travel characteristics, which are used to provide a personalized transit plan that is tailored to the particular user.

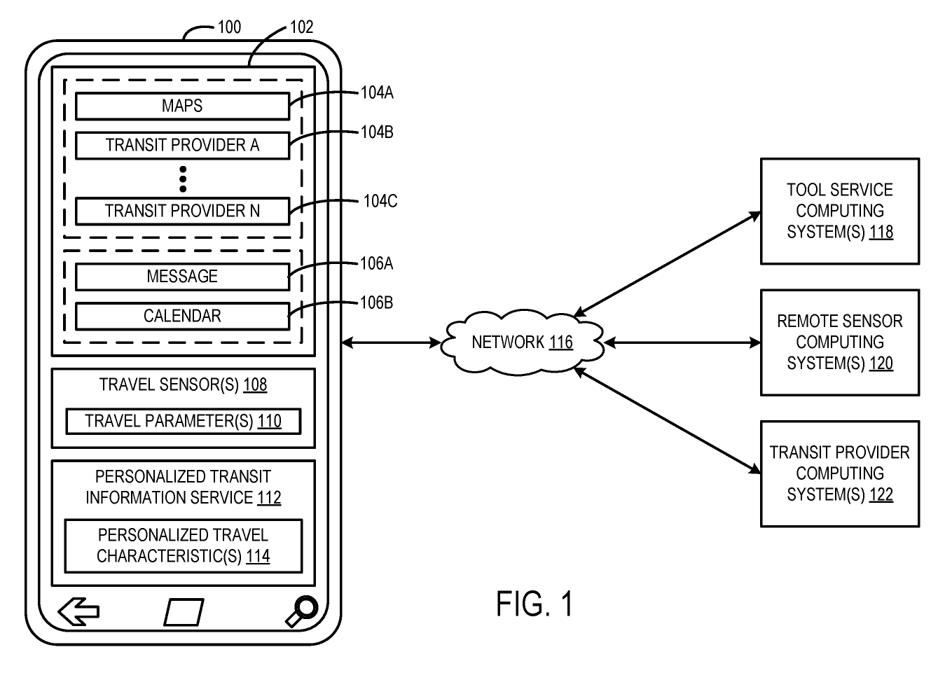

FIG. 1 shows an example mobile computing device 100 in the form of a smart phone. The mobile computing device 100 is shown in simplified form. The mobile computing device 100 includes a display 102 configured to visually present, among other things, travel information related to a variety of different travel tools 104 executable by the mobile computing device 100. Display 102 may employ any suitable type of display technology. In some implementations, display 102 includes a touch-screen sensor configured to receive touch input from a user. As examples, the touch sensor may be resistive, capacitive, or optically based.

The plurality of different travel tools 104 are configured to provide different travel-related information and/or perform travel-related operations. In the illustrated implementation, the mobile computing device 100 includes a maps tool 104A configured to visually present maps of geographical regions, such as road maps, geographical maps, and satellite views. The maps tool 104A may present various points of interest, such as restaurants, gas stations, landmarks, tourist sites, and other relevant travel information. Further, the maps tool 104A may be configured to provide transit planning information (e.g., directions) for drivers, bikers, walkers, and users of public transportation who want to take a trip from one location to another destination.

Further, the mobile computing device 100 includes a plurality of different transit provider tools 104B, 104C. Each transit provider tool corresponds to a different transit provider (A-N) that provides a form of transit that a user of the mobile computing device 100 can use to travel to a desired destination. Non-limiting examples of different transit providers include, but are not limited to, bus companies, rail-vehicle (e.g., heavy rail, light rail, street car) companies, boat companies (e.g., municipal ferry, water taxi), airline companies, and vehicle-for-hire companies taxicab, limousine, Uber®, Lyft®, rental car, CAR2GO®).

Each transit provider tool 104B, 104C is configured to provide transit information and/or transit services related to a form of transit provided by that particular transit provider. For example, in the case of a bus company, the bus transit provider tool may provide transit information in the form of bus routes, bus schedules, fare prices, and other bus related information. Further, the bus transit provider tool may be configured to provide transit services in the form of enabling a user to purchase a ticket to ride the bus.

In another example, in the case of a vehicle-for-hire company, the vehicle-for-hire transit provider tool may provide transit information in the form of identifying available vehicles for hire that are proximate to the current location of the mobile computing device 100, and the rates to hire those vehicles. Further, the vehicle-for-hire transit provider tool may provide transit services in the form of enabling a user to schedule a pickup, hire, or rent a particular vehicle of the transit provider. The plurality of transit provider tools 104B, 104C may provide any suitable form of transit information and/or transit services related to a form of transit of the transit provider. In some implementations, a transit provider may provide transit information and/or transit services related to more than one type of transit modality. For example, a transit provider may provide transit information for both bus and train routes.

Furthermore, the mobile computing device 100 includes a plurality of tools 106 related to other user activities, such as a message tool 106A and a calendar tool 106B. The message tool 106A is configured to send personal messages (e.g., email, SMS message, social network message) and other types of communications (e.g., voice call, video chat) to remote computing devices. The calendar tool 106B is configured to manage appointments, tasks, and other time management information for a user. The mobile computing device 100 may be configured to execute any suitable number and/or type of different tools.

In some implementations, various tools may be pre-loaded onto the mobile computing device 100 by a manufacturer. In some implementations, various tools can be downloaded to the mobile computing device 100 by communicating with a remote computing device via a network 116, such as the Internet. For example, the mobile computing device 100 may download a tool from one or more tool service computing systems 118, such as a virtual marketplace. In particular, a user may browse through a plurality of different tools available for download on a virtual marketplace, and select a desired tool to download to the mobile computing device 100.

Furthermore, the tool service computing systems 118 may include remote services that perform various support operations of the plurality of tools 104, 106. In other words, in some cases, at least some functionality of a particular tool may he performed by a corresponding remote tool service computing system 118. In one example, in the case of the maps tool 104A, the remote tool service computing system 118 includes a maps service configured to, among other operations, send various portions of different maps and related travel information to the mobile computing device 100 to be presented by the maps tool 104A. In another example, in the case of the calendar tool 106B, the remote tool service computing system 118 includes a calendar service that, among other operations, is configured to synchronize a user's calendar of events between different devices of the user. The tool service computing system 118 may include any suitable service configured to perform operations related to the plurality of tools 104, 106 of the mobile computing device 100.

The mobile computing device 100 includes one or more travels sensors 108 configured to measure one or more travel parameters 110 of the mobile computing device. A travel parameter may include any suitable physical parameter that characterizes motion, position, location, and/or other travel information related to the mobile computing device 100. The travel sensors 108 may include any suitable type of sensor. Non-limiting examples of travel sensors include, but are not limited to an inertial measurement unit (IMU) configured to provide position and/or orientation information of the mobile computing device 100; a global positioning system (GPS) sensor configured to provide a geographical location of the mobile computing device 100 via communication with a GPS satellite network; a personal activity tracker configured to track different physical parameters of a user (e.g., count a number of steps, count a number calories burned) of the mobile computing device 100; one or more barometers configured to measure atmospheric pressure at a location of the mobile computing device 100, and a clock/timer to trigger various travel related events (e.g., a travel deviation condition). Further, various travel parameters may be derived from such travel sensors, such as speed, acceleration, height, and other suitable parameters.

In some implementations, one or more travel parameters may be provided to the mobile computing device 100 from one or more remote sensor computing systems 120. In one example, the remote sensor computing systems may include cellular communication towers configured to communicate with the mobile computing device 100 to determine a position of the mobile computing device 100 (e.g., via signal localization).

In some implementations, the remote sensor computing systems 120 may be configured to measure travel parameters of remote computing devices other than the mobile computing device 100. In one example, the remote sensor computing systems 120 are configured to provide travel parameters (e.g., speed) for one or more vehicles on a route of a vehicle on which the user of the mobile computing device 100 is riding. For example, such travel parameters of remote vehicles may be used to determine traffic delay times on the route or other potential routes that may be taken by the user. In another example, the remote sensor computing systems 120 are configured to provide travel parameters (e.g., current speed) for transit vehicles (e.g., buses, trains) that a user of the mobile computing device 100 may ride as part of a transit plan to reach a destination. For example, such travel parameters may be used to determine whether a vehicle on a predetermined route is running on schedule.

While specific examples of travel sensors have been described, the mobile computing device 100 may include any other suitable sensors for tracking travel-related information of a user. For example, the mobile computing device 100 may include visible-light sensors, ultraviolet sensors, ambient temperature sensors, and contact sensors. Such sensors may measure any suitable physical parameter. Further, such sensors may be in communication with one or more circuits or other machines of the mobile computing device configured to translate measurements of the physical parameters into machine-readable sensor data. The mobile computing device 100 may be configured to use the machine-readable sensor data to perform operations that enable functionality of the tools 104, 106, as well as a personalized transit information service 112 as described in further detail below.

The personalized transit information service 112 is configured to proactively present personalized transit notifications during travel based on dynamically changing travel conditions. The transit notifications may include transit plans that describe a route using one or more transit modalities (e.g., bus, train, vehicle-for-hire) to travel between a current location and a determined destination. The personalized transit information service 112 is configured to automatically detect a destination of the user for which a transit plan is devised based on personalized travel characteristics 114 of the user. The personalized travel characteristics 114 may describe travel behaviors, associations, preferences, history, and other travel information that is particular to the user of the mobile computing device 100. The personalized transit information service 112 may determine the personalized travel characteristics 114 of the user in any suitable manner.

In one example, the personalized travel characteristics 114 include locations associated with the user of the mobile computing device 100. Such locations may be acquired via direct knowledge of the user. For example, the user may provide locations for work, home, school, and other user-associated locations via user input, such as during a setup or registration process of the mobile computing device 100.

In another example, the personalized travel characteristics 114 include one or more prior destinations identified based on previous user travel activity. For example, the personalized transit information service 112 may track movement of the mobile computing device 100 based on the travel parameters 110. Further, the personalized transit information service 112 may determine common travel routines including commonly visited destinations (e.g., home, work) based on the travel parameters 110. In another example, the personalized transit information service 112 may determine a destination based on a fare for public transportation to a particular destination purchased via one of the transit provider tools 104A, 104B or via another purchase method. For example, the personalized transit information service 112 may determine that a destination of the user is a location in Seattle based on the user buying a train ticket to Seattle using the mobile computing device 100.

In another example, the personalized travel characteristics 114 include an appointment having a time and a location specified in the calendar tool 106B. In this case, the personalized transit information service 112 determines a destination of the user directly from the appointment information.

In another example, the personalized travel characteristics 114 include destination information extracted from user messaging activity on the mobile computing device 100. In particular, the personalized transit information service 112 is configured to recognize travel or destination keywords/phrases in emails, SMS messages, video chats, and other types of messaging activity to determine the destination of the user. For example, a user may send a text message stating, “I will meet you at the train station at 1:00 PM.” The personalized transit information service 112 may recognize the keywords “train station” and “1:00 PM” to determine the destination and devise a transit plan for the user to reach the train station by 1:00 PM.

Although, the personalized transit information service 112 is configured to automatically determine a destination from various personalized travel characteristics of the user, in some cases, the personalized transit information service 112 may determine a destination directly from user input that specifies the destination. For example, the user may request direction to a destination via the maps tool 104A.

The personalized transit information service 112 is configured to determine a transit plan for the user to travel from a current location to a determined destination using travel information provided, at least in part, by the plurality of travel tools 104 and/or the remote tool service computing systems 118. A transit plan may be determined based on any suitable factors. In one example, a transit plan may be determined based on a shortest time to reach a destination. In another example, a transit plan may be determined based on a lowest cost to travel to a destination. In another example, a transit plan may be determined based on only using public transportation. In some cases, a transit plan uses only one transit modality ride a bus) to reach a destination. In some cases, a transit plan uses multiple transit modalities (e.g., ride a train and then a bus) to reach a destination.

In some implementations, the personalized transit information service 112 is configured to determine a transit plan based on one or more user-associated transit providers. In particular, the personalized transit information service 112 may be configured to determine a plurality of different candidate transit plans, and select a particular transit plan from the plurality of different candidate transit plans based on the one or more user-associated transit providers. The personalized transit information service 112 may determine a user-associated transit provider in any suitable manner. In one example, the personalized transit information service 112 determines user-associated transit providers based on transit provider tools loaded on the mobile computing device 100. In another example, the personalized transit information service 112 determines user-associated transit providers based on user subscriptions or purchase history with a particular transit provider. For example, if a user has previously purchased a train ticket using a particular train company, then the personalized transit information service 112 may favor a transit plan that includes that train company over other transit plans that include other train companies when selecting a particular transit plan for the user.

The personalized transit information service 112 is configured to visually present, via display 102, an initial transit plan to reach a user destination.

In some implementations, the personalized transit information service 112 may be configured to determine that a language in which information is presented by the mobile computing device differs from a native language of a current location of the mobile computing device. For example, the personalized transit information service 112 may communicate with remote tool service computing systems 118 (e.g., a map provider) and/or remote transit provider computing systems 122 corresponding to a current geographical location that provide information in a language that differs from the language of the mobile computing device (e.g., a language set by the user). Accordingly, the personalized transit information service 112 may translate any travel information in a different native language that is received from such remote computing systems to a language of the mobile computing device 100. Accordingly, the user may be able to comprehend travel information and notifications of transit plans even when the user is traveling in a region that has a different language and/or alphabet.

Furthermore, during travel to the user destination according to the initial transit plan, the personalized transit information service 112 is configured to measure travel parameters 110 of the mobile computing device. In particular, the personalized transit information service 112 is configured to recognize a travel deviation condition based on the one or more travel parameters 110.

A travel deviation condition may include any suitable condition in which the initial transit plan is made less viable, accurate, or optimal than an alternative transit plan as determined by the personalized transit information service 112. In one example, a travel deviation condition may be recognized based on a current expected arrival time being delayed greater than a threshold time from an initial expected arrival time according to the initial transit plan. For example, such a delay may be due to traffic delays determined from a speed of one or more vehicles traveling on a route of the initial transit plan, or due to an accident that occurs on the route. In another example, such a delay may be due to due mechanical issues of a vehicle on which the user is riding—e.g., a bus breaks down, debris is across a train track. In this example, the personalized transit information service 112 may recognize the delay based on a position of the mobile computing device 100 being the same or moving slowing for a threshold duration.

A travel deviation condition may be triggered in any suitable manner. For example, any suitable time threshold may be used to trigger a deviation condition. Moreover, different travel deviation conditions may be triggered by different threshold times. For example, a threshold time to deviate from a transit plan due to a traffic delay may be shorter than a threshold time to deviate from a transit plan due to standing at a bus stop.

In another example, a deviation condition may include a change in a user destination that make the initial transit plan invalid. In one example, while a user is traveling to the user destination according to the initial transit plan, the personalized transit information service 112 may recognize that a friend of the user is located nearby the current location of the mobile computing device 100 from user messaging activity or other personalized travel characteristics, such as a social network post made by the friend. Accordingly, the personalized transit information service 112 recognizes that the user may want to deviate from the initial transit plan in order to visit the friend.

In another example, the personalized transit information service 112 is configured to recognize a travel deviation condition by recognizing that an alternative vehicle will arrive at a transit station within a threshold distance of a current location of the mobile computing device within a threshold time of a current time, and further recognize that use of the alternative vehicle from the transit station is scheduled to cause an earlier arrival at the user destination than the initial transit plan. For example, a user may be waiting for a bus at a bus station as part of an initial transit plan. The personalized transit information service 112 may recognize that a train station in within walking distance of the bus station, and a train will leave from the train station and arrive proximate to the user destination earlier than the bus. As such, the personalized transit information service 112 may deviate from the initial transit plan and notify the user of an alternative transit plan that includes the train. In some cases, the alternative transit plan may replace a single transit vehicle (e.g., riding a train) of an initial transit plan with multiple transit vehicles (e.g. riding a bus and subway.

The personalized transit information service 112 is configured to present, via the display 102, a notification of an alternative transit plan based on recognizing the travel deviation condition. The notification may take any suitable form. In some implementations, the mobile computing device 100 may present at least a part of the notification in audio form. In some implementations, the mobile computing device 100 may present the notification in audio form without presenting the notification via the display 102. The alternative transit plan may enable the user to arrive at the user destination earlier than an expected arrival time of the initial transit plan due to dynamic changes in travel conditions as the use travels to the user destination.

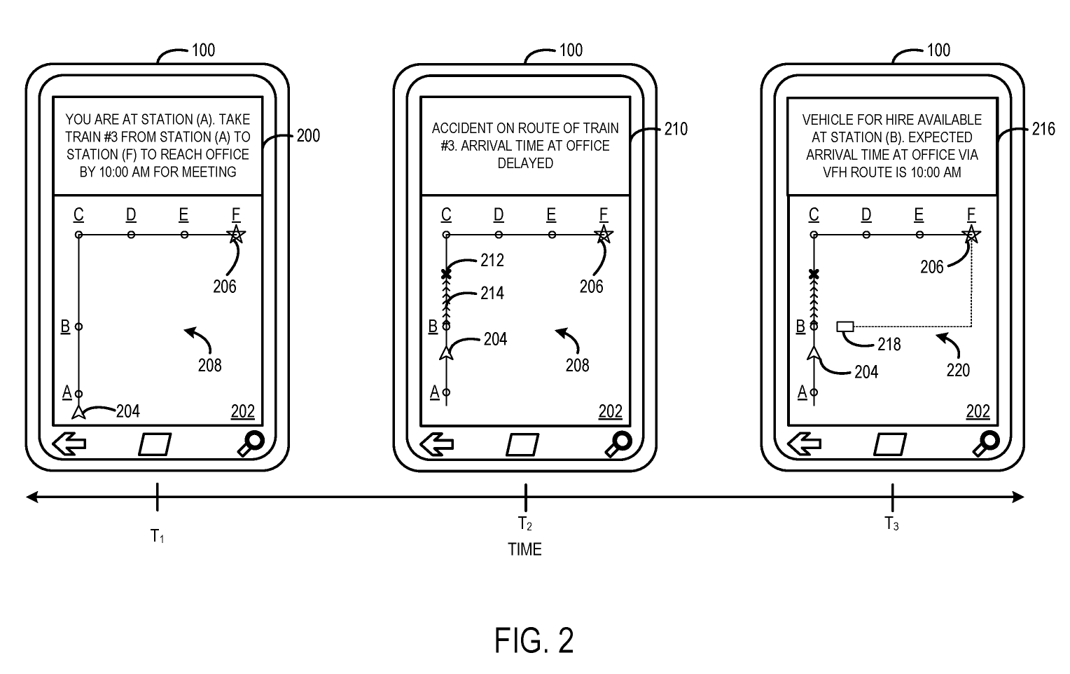

Additional scenarios in which the personalized transit information service 112 presents a notification of an alternative transit plan based on a deviation condition are discussed below with reference to FIGS. 2-5.

FIG. 2 shows a scenario in which the mobile computing device 100 presents an alternative transit plan that employs a transit modality that differs from a transit modality of an initial transit plan in order for the user to reach a user destination by a specified time. In particular, at time T₁, the mobile computing device 100 presents a notification 200 of an initial transit plan as well as a map 202 showing a route according to the initial transit plan. The map 202 shows a current position indicator 204, a user destination indicator 206, and a route indicator 208 of the initial transit plan. In particular, the notification 200 of the initial transit plan indicates that the user is located at train station A, and the user is to take train #3 from train station A to train station F to reach the user's office by 10:00 AM for a meeting. In this scenario, the personalized transit information service 112 determines the user destination and the arrival time of 10:00 AM based on an appointment listed in a user calendar in the calendar tool 106B of the mobile computing device 100.

At a time subsequent to time the personalized transit information service 112 recognizes a deviation condition in the form of an accident on the route of train #3 that will delay the arrival time of the user at the user destination. In one example, the personalized transit information service 112 recognizes the deviation condition from accident information received by the transit provider tool corresponding to the train company that is on the mobile computing device 100. In another example, the personalized transit information service 112 recognizes the deviation condition based on a speed measured by a sensor of the mobile computing device 100 being less than a threshold speed for a threshold duration. For example, the threshold speed may he substantially less than a cruising speed of the train.

At time T₂, the mobile computing device 100 presents a notification 210 indicating that an accident has occurred on the route of train #3 that will delay the expected arrival time of the user at the user's office to a time after the 10:00 AM appointment. Further, the map 202 shows an accident indicator 212 and a delay region 214. The accident indicator 212 indicates a location on the route indicator 208 where the accident occurred. The delay region 214 indicates a region of the route that is affected by the accident.

At time T₃ subsequent to time T₂, the mobile computing device 100 presents a notification 216 of an alternative transit plan that can be used to reach the user's office by an expected arrival time of 10:00 AM that allows the user to attend the appointment. In particular, the notification 216 of the alternative travel plan indicates that a vehicle for hire (e.g., an Uber®) is located at train station B. The map 202 shows a vehicle-for-hire indicator 218 that indicates a location of the vehicle for hire. The map 202 also shows an optimal route 220 that the vehicle for hire (VFH) can travel to reach the user's office as indicated by user destination indicator 206 in time to snake the 10:00 AM appointment.

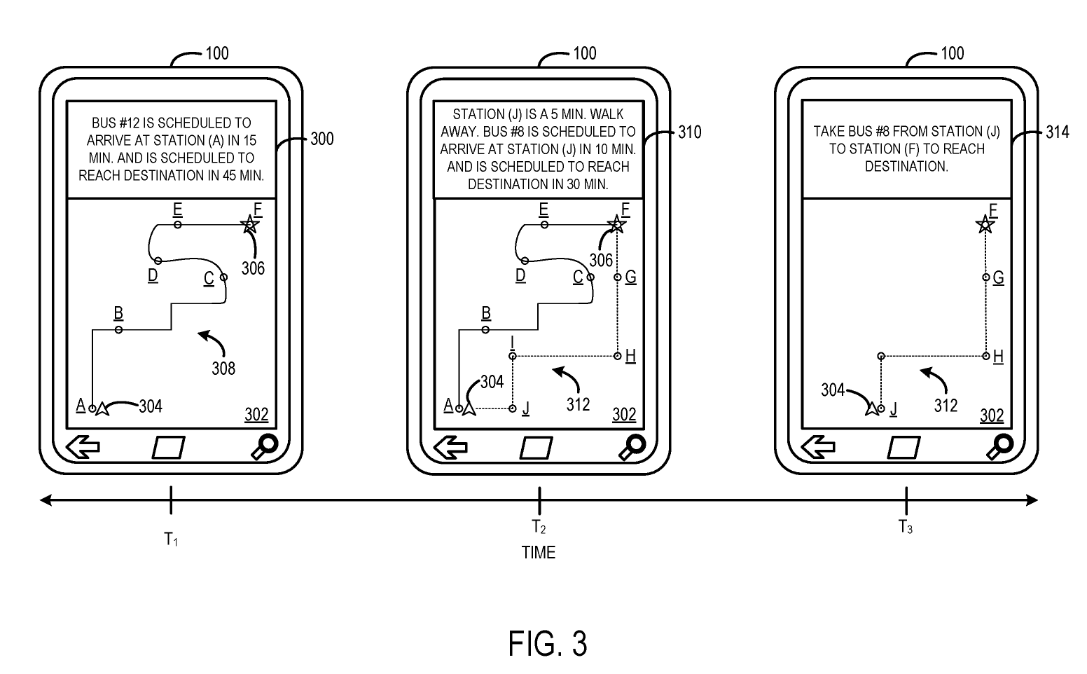

FIG. 3 shows another scenario in which the mobile computing device 100 presents alternative transit plan that includes riding a different bus that is further away from a current position in order to reach a user destination prior to an initial bus included in an initial transit plan. In particular, at time T₁, the mobile computing device 100 presents a notification 300 of an initial transit plan as well as a map 302 showing a route according to the initial transit plan. The map 302 shows a current position indicator 304, a user destination indicator 306, and a route indicator 308 of the initial transit plan. In particular, the notification 300 of the initial transit plan indicates that the user is located at bus station A, bus #12 is scheduled to arrive at bus station A in 15 minutes, and the user can ride bus #12 to bus station F to reach the user destination in 45 minutes. For example, the initial transit plan be determined by the mobile computing device 100 based on the position of the mobile computing device 100 relative to bus station A, the arrival time of bus #12 at station A, and the position of the user destination relative to the route of bus #12.

At time T₂ subsequent to time T₁, the personalized transit information service 112 recognizes a deviation condition in the form of the mobile computing device 100 staying in the same location for greater than a threshold duration—e.g., while waiting for bus #12 to arrive at bus station A. As such, the mobile computing device 100 devises an alternative transit plan based on recognizing the deviation condition.

Furthermore, the mobile computing device 100 presents a notification 310 of the alternative transit plan that can be used to reach the user destination at an expected arrival time prior to an expected arrival time estimated for the initial transit plan. In particular, the notification 310 of the alternative travel plan indicates that a bus station J is a 5-minute walk from bus station A. A bus #8 will be arriving at bus station J in 10 minutes, and the bus #8 will arrive at bus station F to reach the user destination in 30 minutes. The map 302 shows the current position indicator 304 of the mobile computing device 100 relative to bus station A and bus station J. Further, the map 302 shows a route indicator 312 of bus #8 to reach the user destination as indicated by user destination indicator 306.

At time T₃ subsequent to time T₂, the mobile computing device 100 presents a notification 314 indicating the alternative transit plan as the user is walking to bus station J. The mobile computing device 100 may continue to present the notification 314 to remind the user where to go as a position of the mobile computing device 100 changes. Furthermore, the map 302 shows the current position indicator 304 with an updated position relative to the updated route indicator 312 as the mobile computing device 100 moves closer to bus station J.

In this scenario, the personalized transit information service 112 recognizes that although bus station J is further away from the position of the mobile computing device 100 than bus station A, bus #8 will ultimately arrive at the user destination earlier than the bus #12. Accordingly, the personalized transit information service 112 proactively presents notifications of the alternative transit plan in order for the user to travel in more time efficient manner.

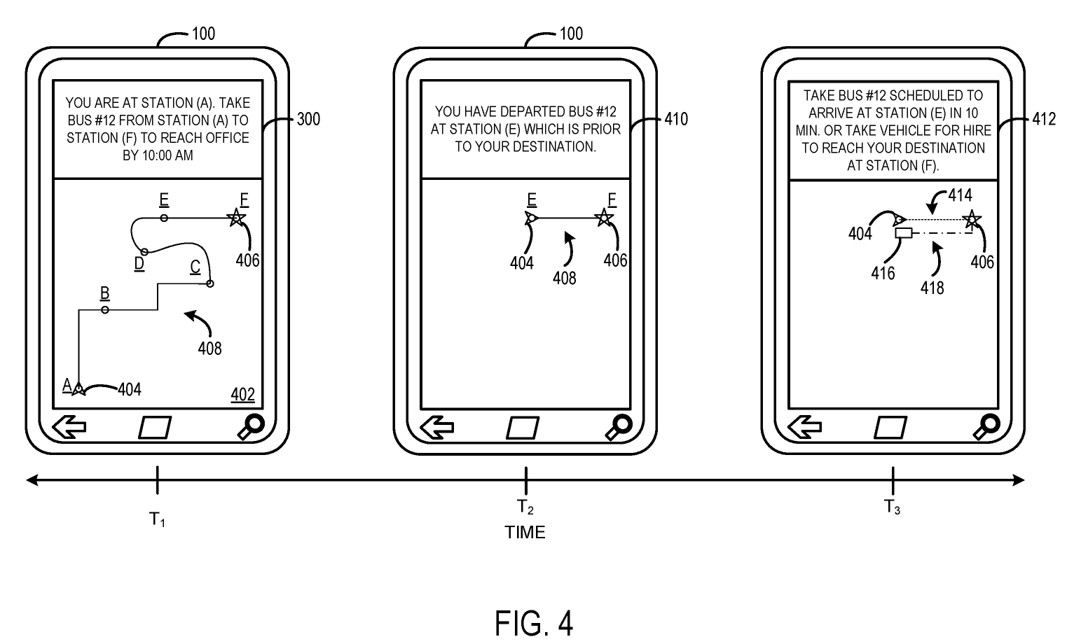

FIG. 4 shows a scenario in which the mobile computing device 100 presents an alternative transit plan to correct a user error in following an initial transit plan in order for the user to reach a user destination by a specified time. In particular, at time T₁, the mobile computing device 100 presents a notification 400 of an initial transit plan as well as a map 402 showing a route according to the initial transit plan. The map 402 shows a current position indicator 404, a user destination indicator 406, and a route indicator 408 of the initial transit plan. In particular, the notification 400 of the initial transit plan indicates that the user is located at bus station A, and the user is to take train #12 from bus station A to bus station F to reach the user's office by 10:00 AM for a meeting.

At time T₂ subsequent to time T₁, the personalized transit information service 112 recognizes a deviation condition in the form of the user departing bus #12 at bus station E instead of bus station F. For example, the personalized transit information service 112 may recognize the deviation condition based on a speed of the mobile computing device 100 lowering from a traveling speed of the bus to a walking speed of the user for a threshold duration. As such, the mobile computing device 100 presents a notification 410 indicating that the user has departed bus #12 prior to reaching the user destination. Further, the map 402 shows the current position indicator at bus station E, as well as the remaining route indicated by route indicator 408 to reach the user destination as indicated by user destination indicator 406.

At time T₃ subsequent to time T₂, the mobile computing device 100 presents a notification 412 of alternative transit plans that can be used to reach the user's office by an expected arrival time of 10:00 AM that allows the user to attend the appointment. In particular, the notification 412 includes two possible alternative transit plans. The first alternative transit plan indicates that a bus #10 is scheduled to arrive at bus station F in 10 minutes and travel to bus station F to reach the user destination by 10:00 AM. The second alternative transit plan indicates that a vehicle for hire (e.g., an Uber®) is located at train station E. The map 402 shows the route of bus #12 from bus station E to bus station F via route indicator 414. Further, the map 402 shows a vehicle-for-hire indicator 416 that indicates a location of the vehicle for hire relative to the current position indicator 404. The map 402 also shows an optimal route 418 that the vehicle for hire can travel to reach the user's office as indicated by user destination indicator 406 in time to make the 10:00 AM appointment.

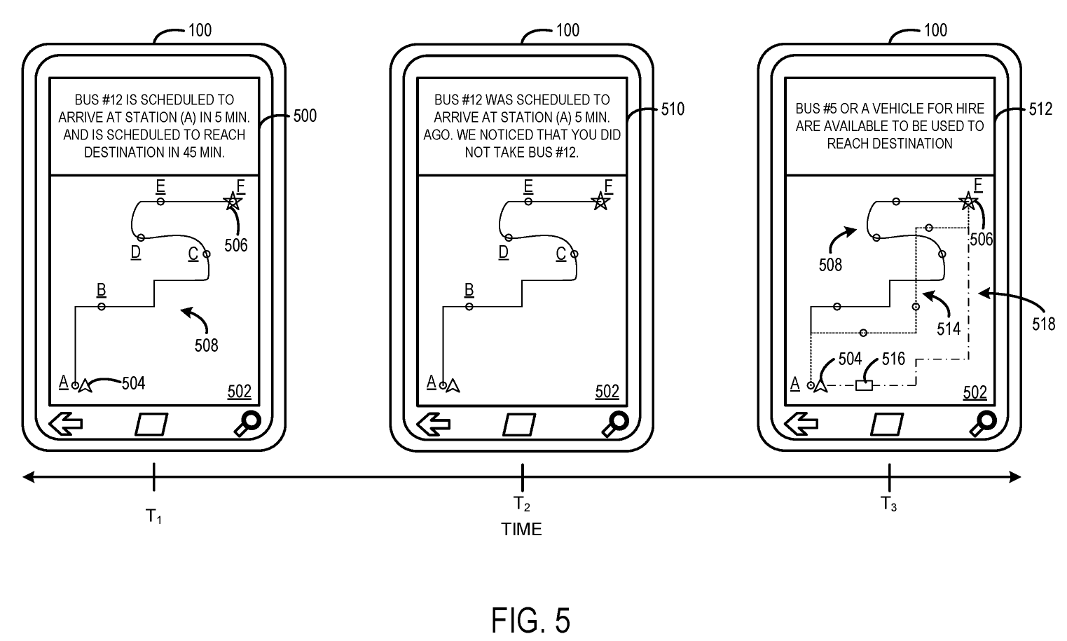

FIG. 5 shows another scenario in which the mobile computing device 100 presents an alternative transit plan based on a user missing a bus included in an initial transit plan. In particular, at time T₁, the mobile computing device 100 presents a notification 500 of an initial transit plan as well as a map 502 showing a route according to the initial transit plan. The map 502 shows a current position indicator 504, a user destination indicator 506, and a route indicator 508 of the initial transit plan. In particular, the notification 500 of the initial transit plan indicates that the user is located at bus station A, bus #12 is scheduled to arrive at bus station A in 5 minutes, and the user can ride bus #12 to bus station F to reach the user destination in 45 minutes.

At time T₂ subsequent to time T₁, the personalized transit information service 112 recognizes a deviation condition in the form of the mobile computing device 100 being at the location of bus station A at a time a threshold duration after the scheduled arrival time of bus #12 at bus station A. In other words the personalized transit information service 112 recognizes that the user has missed bus #12. As such, the mobile computing device 100 devises an alternative transit plan based on recognizing the deviation condition.

Furthermore, the mobile computing device 100 presents a notification 510 indicating that “bus #12 was scheduled to arrive at station A 5 minutes ago. We noticed that you did not take bus #12.” The notification 510 may be presented to alert the user of the error.

At time T₃ subsequent to time T₂, the mobile computing device 100 presents a notification 512 indicating alternative transit plans to reach the user destination. In particular, the notification 512 includes two possible alternative transit plans. The first alternative transit plan indicates that a bus #5 is scheduled to arrive at bus station A imminently and travel to bus station F via a different route than bus #12 to reach the user destination. In particular, this alternative transit plan recommends bus #5, because bus #5 will arrive at the user destination prior to the next instance of bus #12. The second alternative transit plan indicates that a vehicle for hire (e.g., an Uber®) is located within walking distance of station A.

The map 502 shows the route 514 of bus from bus station A to bus station F. Further, the map 402 shows a vehicle-for-hire indicator 516 that indicates a location of the vehicle for hire relative to the current position indicator 504. The map 502 also shows an optimal route 518 that the vehicle for hire can travel to reach the user destination as indicated by user destination indicator 506.

The above described scenarios are provided as examples that are meant to be non-limiting. The mobile computing device 100 may be configured to present a notification of an alternative transit plan that differs from an initial transit plan in any suitable manner based on recognition of any suitable deviation condition.

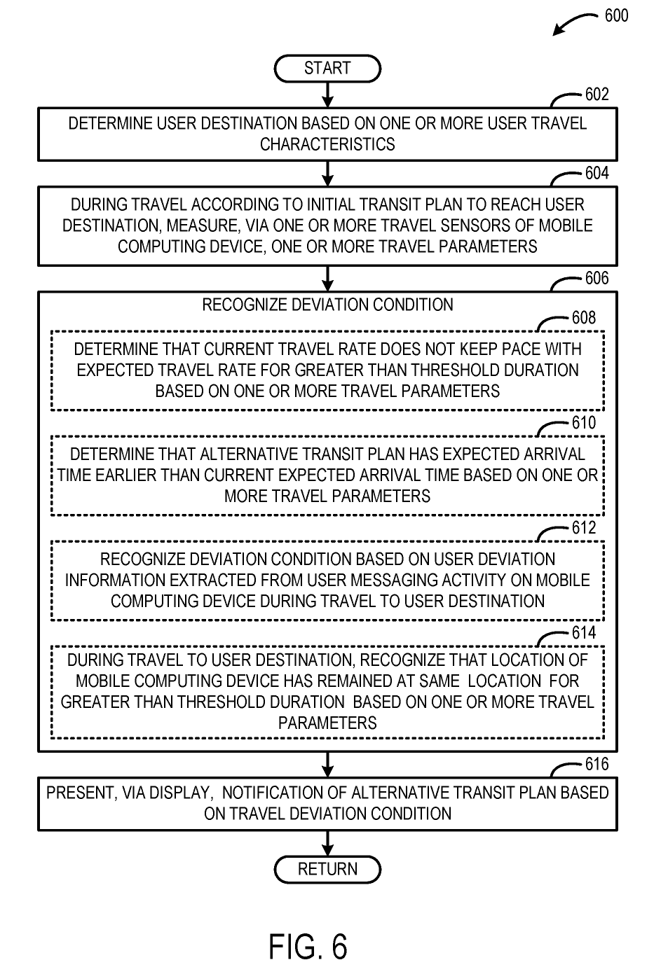

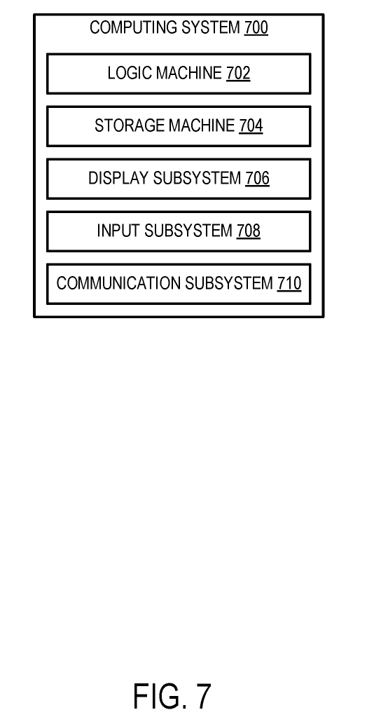

FIG. 6 shows a method 600 for presenting personalized travel information. For example, the method 600 may be performed by the mobile computing device 100 of FIG. 1, the computing system 700 of FIG. 7, or generally any other suitable mobile computing device. At 602, the method 600 includes determining a user destination based on one or more personalized travel characteristics of the user. For example, the personalized travel characteristics may be determined from user activity on the mobile computing device including, but not limited, user messaging activity, scheduling appointments in a user calendar, and tracking previous user travel activity (e.g., via tracking a UPS position of the mobile computing device). At 604, the method 600 includes during travel according to an initial transit plan to reach the user destination, measuring, via one or more travel sensors, one or more travel parameters. The travel parameters may characterize travel information corresponding to the mobile computing device (e.g., location, speed) as well as other remote computing devices, for example to determine traffic conditions or expected arrival time of a public transit vehicle (e.g., speed of a train or bus). At 606, the method 600 includes recognizing a travel deviation condition based on the one or more travel parameters. The travel deviation condition may include any suitable condition that indicates that the initial transit plan is no longer the most accurate or optimal plan for the user to reach a user destination.

In some implementations, recognizing a deviation condition optionally may include, at 608, determining that a current travel rate does not keep pace with an expected travel rate for greater than a threshold duration based on one or more travel parameters. In this case, the travel rate may indicate that there is an issue (e.g., traffic, mechanical breakdown) with the current travel modality of the initial transit plan, and the user may be able to use a different travel modality to reach a user destination more quickly.

In some implementations, recognizing a deviation condition optionally may include, at 610, determining that an alternative transit plan has an expected arrival time that is earlier than a current expected arrival time of the initial transit plan based on the one or more travel parameters. The current expected arrival time may be different than an initial expected arrival time of the initial transit plan based on dynamically changing travel conditions. Such changing conditions may cause an alternative transit plan to be more efficient for the user to reach a user destination.

In some implementations, recognizing a deviation condition optionally may include, at 612, recognizing a deviation condition based on user deviation information extracted from user messaging activity on the mobile computing device. In one example, during the course of travel to an initial user destination, the user decides to travel to a different user destination to meet a friend. The user may send a message to the friend indicating the alternative user destination, and that destination information may be extracted from the message to determine an alternative transit plan to reach the alternative user destination.

In some implementations, recognizing a deviation condition optionally may include, at 614, during travel to a user destination, recognizing that a location of the mobile computing device has remained at the same location for greater than a threshold duration. In this case, the deviation condition may infer that the user is lost or has missed a scheduled public transit vehicle. For example, if the user is standing at a bus stop even after a scheduled bus has come and gone, then a deviation condition may be recognized in order to determine an alternative transit plan.

At 616, the method 600 includes presenting, via a display, a notification of an alternative transit plan based on the travel deviation condition. The alternative transit plan may provide an accurate and efficient route for a user to reach a user destination based on the dynamically changing travel conditions that occur during travel. By proactively presenting an alternative transit plan based on recognizing a travel deviation condition, a user may be provided with a transit plan that accurately fits current user travel needs based on current travel conditions.

In some implementations, the methods and processes described herein may be tied to a computing system of one or more computing devices, in particular, such methods and processes may be implemented as a computer-application program or service, an application-programming interface (API), a library, and/or other computer-program product.

FIG. 7 schematically shows a non-limiting implementation of a computing system 700 that can enact one or more of the methods and processes described above. Computing system 700 is shown in simplified form. Computing system 700 may take the form of one or more personal computers, server computers, tablet computers, home-entertainment computers, network computing devices, gaining devices, mobile computing devices, mobile communication devices (e.g., smart phone), virtual-reality devices, and/or other computing devices. For example, the computing system 700 may be a non-limiting example of the mobile computing system 100 of FIG. 1.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine 702 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 702 may include one or more processors configured to execute software instructions. Additionally or alternatively, the logic machine 702 may include one or more hardware or firmware logic machines configured to execute hardware or firmware instructions. Processors of the logic machine 702 may be single-core or multi-core, and the instructions executed thereon may be configured for sequential, parallel, and/or distributed processing. Individual components of the logic machine 702 optionally may be distributed among two or more separate devices, which may be remotely located and/or configured for coordinated processing. Aspects of the logic machine 702 may be virtualized and executed by remotely accessible, networked computing devices configured in a cloud-computing configuration.

Storage machine 704 includes one or more physical devices configured to hold instructions executable by the logic machine 702 to implement the methods and processes described herein. When such methods and processes are implemented, the state of storage machine 704 may be transformed e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices. As a non-limiting example, display subsystem 706 may include the near-eye displays described above.

When included, input subsystem 708 may comprise or interface with one or more user-input devices such as a keyboard, mouse, touch screen, or game controller. In some implementations, the input subsystem may comprise or interface with selected natural user input (NUI) componentry. Such componentry may be integrated or peripheral, and the transduction and/or processing of input actions may he handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem 710 may allow computing system 700 to send and/or receive messages to and/or from other devices via a network such as the Internet.

In another example, a mobile computing device comprises a display, one or more travel sensors configured to measure one or more travel parameters, a logic machine, and a storage machine holding instructions executable by the logic machine to: determine a user destination based on one or more personalized travel characteristics; during travel according to an initial transit plan to reach the user destination, measure, via the one or more travel sensors, one or more travel parameters; recognize a travel deviation condition based on the one or more travel parameters; and present, via the display, a notification of an alternative transit plan based on the travel deviation condition. In this example, the one or more personalized travel characteristics may include an appointment having a time and a location specified in a user calendar. In this example, the one or more personalized travel characteristics may include one or more prior destinations identified based on previous user travel activity. In this example, the one or more personalized travel characteristics may include destination information extracted from user messaging activity on the mobile computing device. In this example, one or more travel sensors may include one or more of a global positioning system (GPS), one or more motion sensors, a personalized activity tracker, and a timer. In this example, recognizing the travel deviation condition may include: determining a current expected arrival time at the user destination according to the initial transit plan, and determining that the alternative transit plan has an alternative expected arrival time that is earlier than the current expected arrival time. In this example, the initial transit plan may include using a first transit modality to reach the user destination, and the alternative transit plan may include using a second transit modality different than the first transit modality to reach the user destination. In this example, the travel deviation condition may be recognized based on user deviation information extracted from user messaging activity on the mobile computing device during travel to the user destination. In this example, recognizing the travel deviation condition may include: recognizing that an alternative vehicle will arrive at a transit station within a threshold distance of a current location of the mobile computing device within a threshold time of a current time, and recognizing that use of the alternative vehicle from the transit station is scheduled to cause an earlier arrival at the user destination than the initial transit plan. In this example, recognizing the travel deviation condition may include: recognizing that a location of the mobile computing device has remained proximate to a location of a transit station for a duration that is greater than a threshold duration, and the alternative transit plan may be issued based on the duration being greater than the threshold duration. In this example, the one or more personalized travel characteristics may include one or more user-associated transit providers, the alternative transit plan may be one or a plurality of different candidate transit plans, and the storage machine may further hold instructions executable by the logic machine to: select the alternative transit plan from the plurality of different candidate transit plans based on the one or more user-associated transit providers. In this example, the storage machine may further hold instructions executable by the logic machine to: determine that a language in which information is presented by the mobile computing device differs from a native language of a current location of the mobile computing device; and the notification of the alternative transit plan may be issued in the determined language of the mobile computing device.

In another example, on a mobile computing device, a method for providing real-time personalized transit information, the method comprising: determining a user destination based on one or more personalized travel characteristics; during travel according to an initial transit plan to reach the user destination, measuring, via one or more travel sensors, one or more travel parameters; recognizing a travel deviation condition based on the one or more travel parameters; and presenting, via a display, a notification of an alternative transit plan based on the travel deviation condition. In this example, the one or more personalized travel characteristics may include an appointment having a time and a location specified in a user calendar, one or more prior destinations identified based on previous user travel activity, or destination information extracted from user messaging activity on the mobile computing device. In this example, recognizing the travel deviation condition may include: determining a current expected arrival time at the user destination according to the initial transit plan, and determining that the alternative transit plan has an alternative expected arrival time that is earlier than the current expected arrival time. In this example, the initial transit plan may include using a first transit modality to reach the user destination, and the alternative transit plan may include using a second transit modality different than the first transit modality to reach the user destination. In this example, the travel deviation condition may be recognized based on user deviation information extracted from user messaging activity on the mobile computing device during travel to the user destination. In this example, the one or more personalized travel characteristics may include one or more user-associated transit providers, the alternative transit plan may be one or a plurality of different candidate transit plans, and the method may further comprise selecting the alternative transit plan from the plurality of different candidate transit plans based on the one or more user-associated transit providers.

In another example, a mobile computing device comprises a display; one or more travel sensors configured to measure one or more travel parameters; a logic machine; and a storage machine holding instructions executable by the logic machine to: determine a user destination based on one or more personalized travel characteristics; present, via the display, an initial transit plan to reach the user destination by an initial expected arrival time; during travel according to the initial transit plan, measure, via the one or more travel sensors, one or more travel parameters; determine a current expected arrival time according to the initial travel plan based on the one or more travel parameters; and if the current expected arrival time is delayed from the initial expected arrival time by a threshold duration, present, via the display, a notification of an alternative transit plan having an alternative expected arrival time that is earlier than the current expected arrival time. In this example, the initial transit plan may include using a first transit modality to reach the user destination, and the alternative transit plan may include using a second transit modality different than the first transit modality to reach the user destination.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A mobile computing device comprising:
a display;
one or more travel sensors configured to measure one or more travel parameters;
a logic machine; and
a storage machine holding instructions executable by the logic machine to:
determine a user destination based on one or more personalized travel characteristics;
during travel according to an initial transit plan to reach the user destination, measure, via the one or more travel sensors, one or more travel parameters;
recognize a travel deviation condition based on the one or more travel parameters; and
present, via the display, a notification of an alternative transit plan based on the travel deviation condition.

2. The mobile computing device of claim 1, wherein the one or more personalized travel characteristics includes an appointment having a time and a location specified in a user calendar.

3. The mobile computing device of claim 1, wherein the one or more personalized travel characteristics include one or more prior destinations identified based on previous user travel activity.

4. The mobile computing device of claim 1, wherein the one or more personalized travel characteristics include destination information extracted from user messaging activity on the mobile computing device.

5. The mobile computing device of claim 1, wherein one or more travel sensors include one or more of a global positioning system (GPS), one or more motion sensors, a personalized activity tracker, and a timer.

6. The mobile computing device of claim 1, wherein recognizing the travel deviation condition includes:
determining a current expected arrival time at the user destination according to the initial transit plan, and
determining that the alternative transit plan has an alternative expected arrival time that is earlier than the current expected arrival time.

7. The mobile computing device of claim 6, wherein the initial transit plan includes using a first transit modality to reach the user destination, and wherein the alternative transit plan includes using a second transit modality different than the first transit modality to reach the user destination.

8. The mobile computing device of claim 1, wherein the travel deviation condition is recognized based on user deviation information extracted from user messaging activity on the mobile computing device during travel to the user destination.

9. The mobile computing device of claim 1, wherein recognizing the travel deviation condition includes:
recognizing that an alternative vehicle will arrive at a transit station within a threshold distance of a current location of the mobile computing device within a threshold time of a current time, and
recognizing that use of the alternative vehicle from the transit station is scheduled to cause an earlier arrival at the user destination than the initial transit plan.

10. The mobile computing device of claim 1, wherein recognizing the travel deviation condition includes:
recognizing that a location of the mobile computing device has remained proximate to a location of a transit station for a duration that is greater than a threshold duration, and
wherein the alternative transit plan is issued based on the duration being greater than the threshold duration.

11. The mobile computing device of claim 1, wherein the one or more personalized travel characteristics include one or more user-associated transit providers, wherein the alternative transit plan is one or a plurality of different candidate transit plans, and wherein the storage machine further holds instructions executable by the logic machine to: select the alternative transit plan from the plurality of different candidate transit plans based on the one or more user-associated transit providers.

12. The mobile computing device of claim 1, wherein the storage machine further holds instructions executable by the logic machine to:
determine that a language in which information is presented by the mobile computing device differs from a native language of a current location of the mobile computing device; and
wherein the notification of the alternative transit plan is issued in the determined language of the mobile computing device.

13. On a mobile computing device, a method for providing real-time personalized transit information, the method comprising:
determining a user destination based on one or more personalized travel characteristics;
during travel according to an initial transit plan to reach the user destination, measuring, via one or more travel sensors, one or more travel parameters;
recognizing a travel deviation condition based on the one or more travel parameters; and
presenting, via a display, a notification of an alternative transit plan based on the travel deviation condition.

14. The method of claim 13, wherein the one or more personalized travel characteristics includes an appointment having a time and a location specified in a user calendar, one or more prior destinations identified based on previous user travel activity, or destination information extracted from user messaging activity on the mobile computing device.

15. The method of claim 13, wherein recognizing the travel deviation condition includes:
determining a current expected arrival time at the user destination according to the initial transit plan, and
determining that the alternative transit plan has an alternative expected arrival time that is earlier than the current expected arrival time.

16. The method of claim 15, wherein the initial transit plan includes using a first transit modality to reach the user destination, and wherein the alternative transit plan includes using a second transit modality different than the first transit modality to reach the user destination.

17. The method of claim 13, wherein the travel deviation condition is recognized based on user deviation information extracted from user messaging activity on the mobile computing device during travel to the user destination.

18. The method of claim 13, wherein the one or more personalized travel characteristics include one or more user-associated transit providers, wherein the alternative transit plan is one or a plurality of different candidate transit plans, and wherein the method further comprises selecting the alternative transit plan from the plurality of different candidate transit plans based on the one or more user-associated transit providers.

19. A mobile computing device comprising:
a display;
one or more travel sensors configured to measure one or more travel parameters;
a logic machine; and
a storage machine holding instructions executable by the logic machine to:
determine a user destination based on one or more personalized travel characteristics;
present, via the display, an initial transit plan to reach the user destination by an initial expected arrival time;
during travel according to the initial transit plan, measure, via the one or more travel sensors, one or more travel parameters;
determine a current expected arrival time according to the initial travel plan based on the one or more travel parameters; and
if the current expected arrival time is delayed from the initial expected arrival time by a threshold duration, present, via the display, a notification of an alternative transit plan having an alternative expected arrival time that is earlier than the current expected arrival time.

20. The mobile computing device of claim 19, wherein the initial transit plan includes using a first transit modality to reach the user destination, and wherein the alternate transit plan includes using a second transit modality different than the first transit modality to reach the user destination.
